(19) United States
(12) Patent Application Publication
(10) Pub. No.: US 2013/0093803 A1
(43) Pub. Date: Apr. 18, 2013

(54) DISPLAY CONTROL METHOD, DISPLAY CONTROL APPARATUS, LIQUID CRYSTAL DISPLAY APPARATUS, DISPLAY CONTROL PROGRAM, AND COMPUTER READABLE RECORDING MEDIUM

(71) Applicant: Kohji Saitoh, Osaka-shi (JP)

(72) Inventor: Kohji Saitoh, Osaka-shi (JP)

(21) Appl. No.: 13/704,636

(22) PCT Filed: Jul. 27, 2011
(86) PCT No.: PCT/JP2011/067164

§ 371 Date: Dec. 17, 2012

(30) Foreign Application Priority Data
Aug. 3, 2010 (JP) 2010-174451

(51) Int. Cl. G09G 3/36

(52) U.S. Cl. CPC G09G 3/3611
USPC 345/690; 345/102

(57) ABSTRACT

According to a display control method in accordance with the present invention, in a case where an image to be displayed changes in tone between two successive frames, (i) a first dimming process for changing a luminance of a backlight and a second dimming process for changing a level of a tone distribution setting are carried out in a plurality of frame periods in accordance with tones obtained before and after the change, and (ii) at least a second dimming period containing a start timing and a processing time of the second dimming process is controlled in accordance with a temperature of a liquid crystal display panel.

### TECHNICAL FIELD

The present invention relates to a liquid crystal display apparatus which includes a backlight as a light source section for displaying an image, and to display control for changing, in accordance with a tone of an image to be displayed, (i) a luminance of a backlight and (ii) a tone distribution setting (gamma setting) of a liquid crystal display.

### BACKGROUND ART

A liquid crystal display apparatus has excellent features such as flatness, lightweight, and low power consumption, and a users' demand for a high image quality and low power consumption is becoming increasingly higher. Especially, achievement of lower power consumption in portable electronic devices such as mobile phones or PDAs (Personal Digital Assistants) means that single charging allows users to use the portable electronic devices for a longer time. This enhances users' convenience.

A technique for achieving such lower power consumption is exemplified by a CABC (Contents Adaptive Backlight Control) technique. According to the CABC technique, in accordance with a characteristic (tone distribution) of an image to be displayed, a ratio of a luminance of a backlight to a maximum luminance and a tone distribution setting of a display image are controlled. Specifically, assume that a backlight luminance and a tone distribution setting which are obtained in case of a full-screen white display (in a case where tones of all pixels are distributed in maximum values) are a reference backlight luminance and a reference tone distribution setting, respectively (see (a) of FIG. 13). In this case, the reference backlight luminance is at a maximum level, and the reference tone distribution setting shows a relationship between an output tone and an input tone which are in direct proportion to each other.

In contrast to the reference backlight luminance and the reference tone distribution setting, in case of a comparatively dark image, a backlight luminance is lowered by slightly raising a tone distribution setting (i.e., setting a tone distribution setting to be slightly higher than the reference tone distribution setting) (see (b) of FIG. 13). Meanwhile, as an image becomes darker, a tone distribution setting is further raised, thereby further lowering a backlight luminance by the raise in tone distribution setting (see (c) and (d) of FIG. 13).

In a case where an average transmittance of a liquid crystal panel and a ratio of a luminance of a backlight to a maximum luminance are thus balanced in a screen, it is possible to dramatically reduce electric power consumption in the backlight while causing an overall brightness and an appearance of a display image to be substantially unchanged.

However, a liquid crystal response is delayed by a change in image tone. Therefore, in order to change a backlight luminance in accordance with the change in image tone, it is necessary to adjust a timing of the liquid crystal response and a timing of the change in backlight luminance. In a case where these timings are shifted from those in an appropriate correlation, an image disorder such as a flicker due to a luminance change is visible.

Since a liquid crystal response characteristic has a temperature dependence, it is desirable to control the timings in terms of this point.

Patent Literature 1 (mentioned later) discloses a technique for solving a problem such that a flicker occurs as a result of a shift in correlation between a timing of a change in backlight luminance and a timing of an image display due to a change in temperature.

FIG. 12 is a block diagram showing an arrangement of a liquid crystal display apparatus of Patent Literature 1. A liquid crystal display apparatus 100 includes an image characteristic discriminating circuit 101, an image data converting circuit 102, a backlight control circuit 103, a luminance value setting circuit 104 and a timing setting circuit 105 each constituting the backlight control circuit 103, a liquid crystal panel 106, a backlight unit 107, and a temperature measuring means 108 provided in a vicinity of the liquid crystal panel 106 (see FIG. 12).

First, image data desired to be supplied to the liquid crystal panel 106 is supplied to each of the image characteristic discriminating circuit 101 and the image data converting circuit 102. The image characteristic discriminating circuit 101 mainly extracts a characteristic of an image which characteristic is mainly exemplified by a maximum luminance value obtained in the image. Then, the image characteristic discriminating circuit 101 supplies a result of the extraction (i) as backlight luminance data to the luminance value setting circuit 104 and (ii) as image characteristic data to the image data converting circuit 102.

The image data converting circuit 102 converts received image data to display image data in accordance with the image characteristic data, and supplies the display image data to the liquid crystal panel 106.

The luminance value setting circuit 104 sets a backlight luminance value in accordance with the received backlight luminance data. The luminance value setting circuit 104 generates a backlight control signal in accordance with a timing generated by the timing setting circuit 105, and supplies the backlight control signal thus generated to the backlight unit 107.

The timing setting circuit 105 receives temperature data from the temperature measuring means 108 provided in the vicinity of the liquid crystal panel, and adjusts, in accordance with a change in temperature, a timing at which to output the backlight control signal. According to Patent Literature 1, the adjustment allows a change in display image and a change in backlight luminance to occur simultaneously.

### CITATION LIST

### Patent Literature

Patent Literature 1

Japanese Patent Application Publication, Tokukai, No. 2003-255914 (Publication Date: Sep. 10, 2003)

### SUMMARY OF INVENTION

### Technical Problem

However, according to Patent Literature 1, it is preferable in terms of an image quality to set a backlight luminance change time to not more than one (1) ms which is sufficiently shorter than a delay in response of liquid crystal elements (normally several ms to several tens of ms), and to change a backlight luminance at a timing before completion of a change in liquid crystal transmittance.

In a case where the backlight luminance is thus instantly changed in response to the change in image tone in the middle of the change in liquid crystal transmittance, a problem occurs such that a luminance flicker or a great luminance change is visible.

The present invention has been made in view of the problems, and an object of the present invention is to provide a display control technique for preventing, as much as possible, a deterioration in image quality in a liquid crystal display apparatus by use of the CABC technique for changing, in accordance with a characteristic of an image to be displayed, (i) a luminance of a backlight and (ii) a tone distribution of a display image, the liquid crystal display apparatus including a backlight as a light source section for displaying an image.

### Solution to Problem

In order to attain the object, a display control method in accordance with the present invention is

(1) a display control method for changing, in accordance with a characteristic of an image to be displayed in a liquid crystal display panel, (i) a luminance of a backlight which emits light to the liquid crystal display panel and (ii) a tone distribution of the image to be displayed in the liquid crystal display panel,

the display control method including:

(2) a first dimming process for, in order to change first image data of a first frame to second image data of a second frame following the first frame, changing, in a backlight luminance change time which is a plurality of frame periods, a first backlight luminance corresponding to the first image data to a second backlight luminance corresponding to the second image data; and

(3) a second dimming process for changing, in a tone distribution change time which is a plurality of frame periods, a first tone distribution setting corresponding to the first image data to a second tone distribution setting corresponding to the second image data,

the display control method including the step of:

(4) controlling, in accordance with a temperature of the liquid crystal display panel, at least the second dimming period which contains a start timing and a processing time of the second dimming process.

In order to change the image to be displayed from the first image data of the first frame to the second image data of the second frame following the first frame, the method causes a change in luminance of the backlight not instantly in response to a change from the first frame to the second frame but gradually in the backlight luminance change time which is a plurality of frame periods. Namely, the luminance of the backlight reaches the second backlight luminance in a frame which is a plurality of frame periods later than the second frame.

The tone distribution (e.g., a gamma setting) of the liquid crystal display panel is subjected to the second dimming process in which the tone distribution is gradually changed in the tone distribution change time which is a plurality of frame periods.

In a case where the first dimming process and the second dimming process each of which is described above are carried out concurrently, it is possible to display, in the liquid crystal display panel, an image which prevents human eyes from feeling a flicker or a great luminance change.

Note, however, that liquid crystal responsiveness changes in a case where the temperature of the liquid crystal display panel changes in accordance with a geographical or seasonal change in environmental temperature or rises as an operating time of the liquid crystal display panel passes.

According to the display control method of the present invention, the dimming period containing the start timing and the processing time of at least the second dimming process is controlled in accordance with the temperature. This makes it possible to constantly display a high quality image in the liquid crystal display panel regardless of liquid crystal responsiveness.

Note that a processing time of the first dimming process is equivalent to a plurality of frame periods serving as the backlight luminance change time and the processing time of the second dimming process is equivalent to a plurality of frame periods serving as the tone distribution change time. However, it does not mean that (i) the plurality of frame periods serving as the backlight luminance change time and (ii) the plurality of frame periods serving as the tone distribution change time are equal in length.

A display control apparatus in accordance with the present invention is

(1) a display control apparatus which changes, in accordance with a characteristic of an image to be displayed in a liquid crystal display panel, (i) a luminance of a backlight which emits light to the liquid crystal display panel and (ii) a tone distribution of the image to be displayed in the liquid crystal display panel,

the display control apparatus including:

(2) a first dimming process section which controls the luminance of the backlight by carrying out a first dimming process for, in order to change first image data of a first frame to second image data of a second frame following the first frame, changing, in a backlight luminance change time which is a plurality of frame periods, a first backlight luminance corresponding to the first image data to a second backlight luminance corresponding to the second image data; and

(3) a second dimming process section which controls a tone distribution characteristic of the liquid crystal display panel by carrying out a second dimming process for changing, in a tone distribution change time which is a plurality of frame periods, a first tone distribution setting corresponding to the first image data to a second tone distribution setting corresponding to the second image data,

(4) at least the second dimming process section controlling, in accordance with a temperature of the liquid crystal display panel, a second dimming period containing a start timing and a processing time of the second dimming process, the temperature having been obtained via a temperature measuring section which directly or indirectly measures a temperature of the liquid crystal display panel.

According to the arrangement, as in the case of the display control method described earlier, at least the second dimming process section controls, in accordance with the temperature of the liquid crystal display panel, the dimming period containing the start timing and the processing time of the second dimming process, the temperature having been obtained via the temperature measuring section. This makes it possible to constantly display a high quality image in the liquid crystal display panel regardless of liquid crystal responsiveness.

(i) A liquid crystal display apparatus including the display control apparatus (e.g., a mobile phone, a PDA, a personal computer including a display, televisions having various sizes, and a projector), (ii) a display control program causing a computer to function as each of the first dimming process section and the second dimming process section of the display control apparatus, and (iii) a computer-readable recording medium in which the display control program is stored are also encompassed in the scope of the present invention.

### Advantageous Effects of Invention

According to a display control method and a display control apparatus in accordance with the present invention, in a case where an image to be displayed changes in tone between two successive frames, (i) a first dimming process for changing a luminance of a backlight from a first luminance to a second luminance and a second dimming process for changing a tone distribution setting from a first tone distribution setting to a second tone distribution setting are carried out in a plurality of frame periods in accordance with tones obtained before and after the change, and (ii) at least a second dimming period containing a start timing and a processing time of the second dimming process is controlled in accordance with a temperature of a liquid crystal display panel.

This makes it possible to constantly display a high quality image in a liquid crystal display panel regardless of liquid crystal responsiveness depending on a temperature.

### BRIEF DESCRIPTION OF DRAWINGS

FIG. 1

FIG. 1 shows a specific example of a CABC technique carried out at a low temperature in accordance with a display control method of the present invention.

FIG. 2

FIG. 2 shows a specific example of the CABC technique carried out at a normal temperature.

FIG. 3

FIG. 3 is a block diagram showing an arrangement example of a display control apparatus which carries out the display control method.

FIG. 4

FIG. 4 is a block diagram showing an arrangement example of a display control apparatus which does not carry out temperature-based display control.

FIG. 5

FIG. 5 shows another specific example of the CABC technique carried out at the low temperature in accordance with the display control method of the present invention.

FIG. 6

FIG. 6 shows a specific example of the CABC technique carried out at a high temperature in accordance with the display control method of the present invention.

FIG. 7

FIG. 7 shows a specific example of the CABC technique carried out at the normal temperature.

FIG. 8

FIG. 8 shows another specific example of the CABC technique carried out at the high temperature in accordance with the display control method of the present invention.

FIG. 9

FIG. 9 is a block diagram showing another arrangement example of a display control apparatus in accordance with the present invention.

FIG. 10

FIG. 10 shows a display control method for adjusting a BL luminance dimming period start timing and a tone distribution setting dimming period start timing.

FIG. 11

FIG. 11 is a block diagram schematically showing an overall arrangement of a liquid crystal display apparatus in accordance with the present invention.

FIG. 12

FIG. 12 is a block diagram showing an arrangement of a conventional liquid crystal display apparatus.

FIG. 13

FIG. 13 shows a correspondence between a tone distribution setting and a backlight luminance level for a common CABC technique.

### DESCRIPTION OF EMBODIMENTS

Embodiments of the present invention are described below with reference to the drawings. Note that the following description and illustration of the drawings merely serve as an example for convenience of description of the present invention and the present invention is not limited to the example.

### Dimming Process

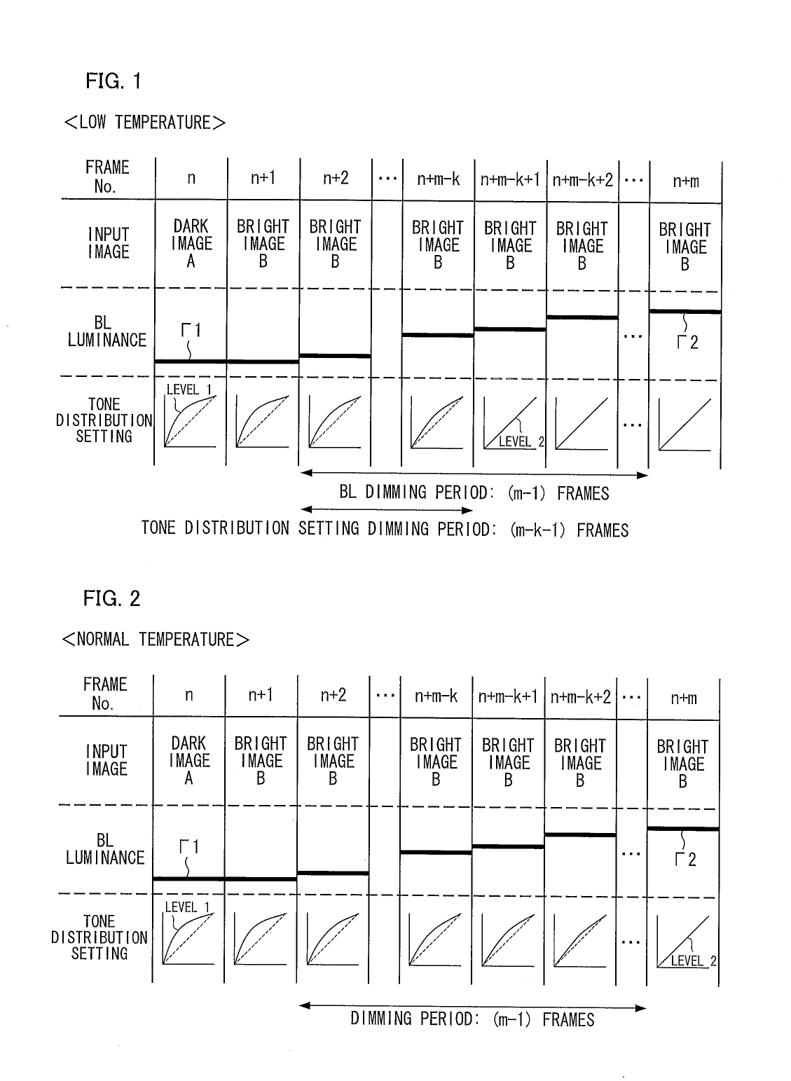

FIG. 1 shows a specific example of a CABC technique carried out at a low temperature in accordance with a display control method of the present invention. Unlike a conventional technique in which a luminance of a backlight which emits light to a liquid crystal display panel (hereinafter abbreviated as a BL luminance) is constantly controlled to be a maximum luminance regardless of a tone distribution characteristic of a display image, the CABC technique is a technique in which a backlight luminance and a tone distribution setting are controlled in accordance with the display image.

A process described below is referred to as a dimming process. According to the dimming process, control is carried out so that a backlight luminance (hereinafter referred to as a BL luminance) or a tone distribution setting is changed in a plurality of frame periods (a change period).

Note that an “average tone” described later refers to a tone obtained by averaging, for all pixels constituting a display screen of a liquid crystal display panel, tones to be displayed in the respective pixels, or by averaging the tones, for a target region of a plurality of regions obtained by dividing the display screen. The “average tone” serves as a criterion indicative of a tone distribution of a display image. Actually, a histogram analytic method in which the number of pixels using each tone is counted for the each tone is used to analyze a tone distribution characteristic of an image. For convenience, a description is given here assuming that a tone distribution characteristic of an image can be expressed by the average tone.

The present invention refers to the following process as a first dimming process. According to the first dimming process, in a case where a first average tone (a dark image A) of a frame n (a first frame) is changed to a second average tone (a bright image B) of a frame (n+1) (a second frame) following the frame n, a BL luminance is changed, in a luminance change time which is a plurality of frame periods, from a luminance Γ′1 (a first luminance) corresponding to the first average tone to a luminance Γ′2 (a second luminance) corresponding to the second average tone (see FIG. 1).

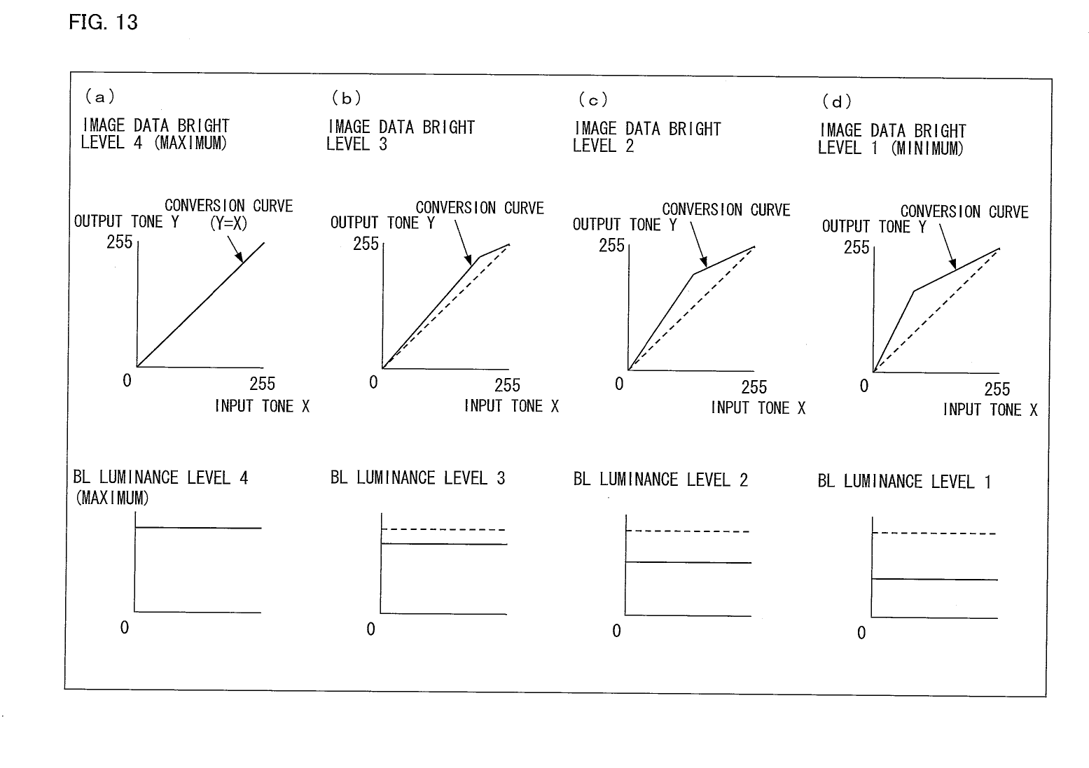

Note that the bright image B is assumed to be an image of a full-screen white display for convenience of description. In this case, the luminance Γ′2 is equivalent to a BL luminance level 4 (maximum) (see (a) of FIG. 13), and a level 2 which is a tone distribution setting corresponding to the bright image B is equivalent to a basic tone distribution setting in which an output tone and an input tone are in direct proportion to each other (see (a) of FIG. 13).

In FIG. 1, a tone of an image is changed from the first average tone to the second average tone in one (1) frame period. In contrast, the BL luminance is maintained at the luminance Γ′1 in the frame (n+1), starts rising in a frame (n+2), and reaches the luminance Γ′2 in a frame (n+m). Therefore, the BL luminance changes from the luminance Γ′1 to the luminance Γ′2 in (m−1) frame periods. That is, a BL luminance change time is (m−1) frame periods.

The following process is referred to as a second dimming process. According to the second dimming process, in accordance with the change from the first average tone to the second average tone, a level 1 which is a tone distribution setting corresponding to the first average tone (a first tone distribution setting) is changed, in a tone distribution change time which is a plurality of frame periods, to a level 2 which is a tone distribution setting corresponding to the second average tone (a second tone distribution setting).

In FIG. 1, the tone distribution setting is maintained at the level 1 in the frame (n+1), starts changing in the frame (n+2), and reaches the level 2 in a frame (n+m−k+1). Therefore, the tone distribution change time is (m−k−1) frame periods.

In a case where the first dimming process and the second dimming process each of which is described above are carried out concurrently, it is possible to display, in a liquid crystal display panel, an image which prevents human eyes from feeling a flicker or a great luminance change.

### Point of Display Control Method

A display control method of the present invention is characteristic in that of a first dimming period containing a start timing and a processing time of the first dimming process (hereinafter referred to as a BL luminance dimming period) and a second dimming period containing a start timing and a processing time of the second dimming process (hereinafter referred to as a tone distribution setting dimming period), at least the tone distribution setting dimming period is controlled in accordance with a temperature of the liquid crystal display panel.

Liquid crystal responsiveness changes in a case where the temperature of the liquid crystal display panel changes in accordance with a geographical or seasonal change in environmental temperature or rises as an operating time of the liquid crystal display panel passes. For example, in a case where a user possessing a mobile phone moves from a warm region to a cold region, a liquid crystal response speed becomes low. This makes it impossible in the cold region to obtain, as it is, an image quality which can be obtained in the warm region at a normal temperature.

According to the display control method of the present invention, at least the tone distribution setting dimming period is controlled in accordance with a temperature. According to this, even if the temperature of the liquid crystal display panel changes, a correspondence between the BL luminance and the level of the tone distribution setting can be close to or substantially equal to the correspondence at the normal temperature. This makes it possible to constantly display a high quality image in the liquid crystal display panel regardless of liquid crystal responsiveness.

Note that, since a rate of change in backlight luminance shows no temperature dependence, the BL luminance dimming period may be maintained in without being controlled in accordance with the temperature.

### Embodiment 1

### Main Arrangement of Display Control Apparatus

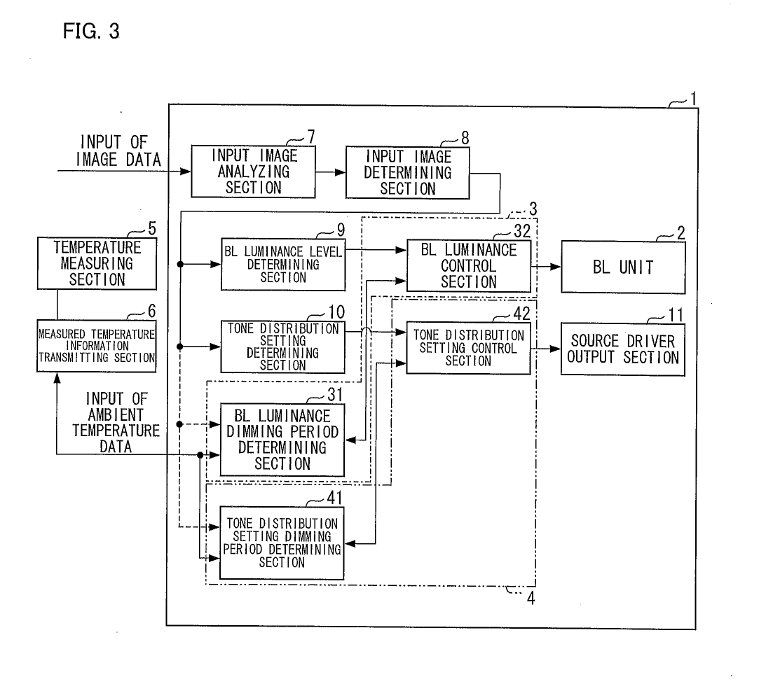

FIG. 3 is a block diagram showing an arrangement example of a display control apparatus which carries out the display control method.

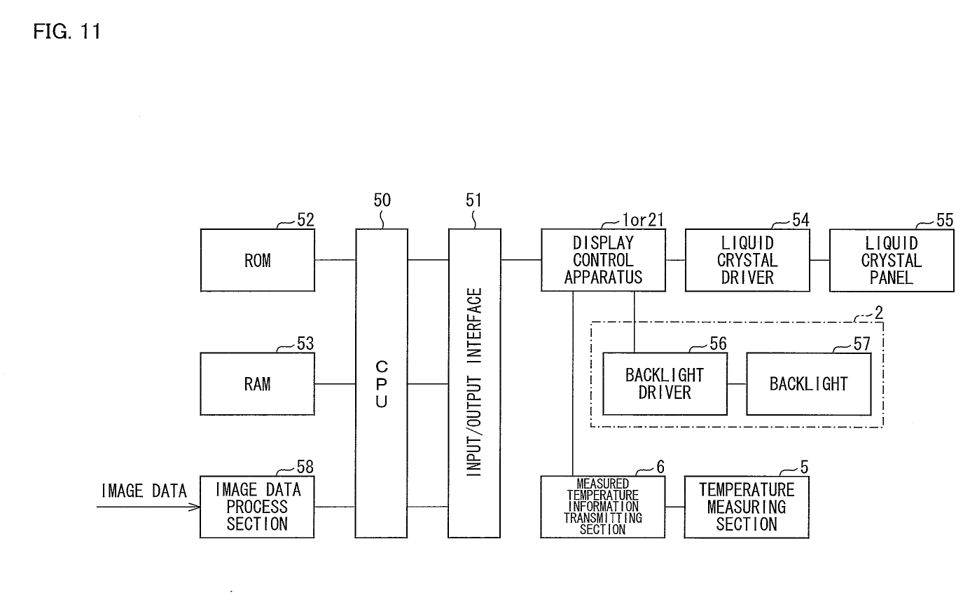

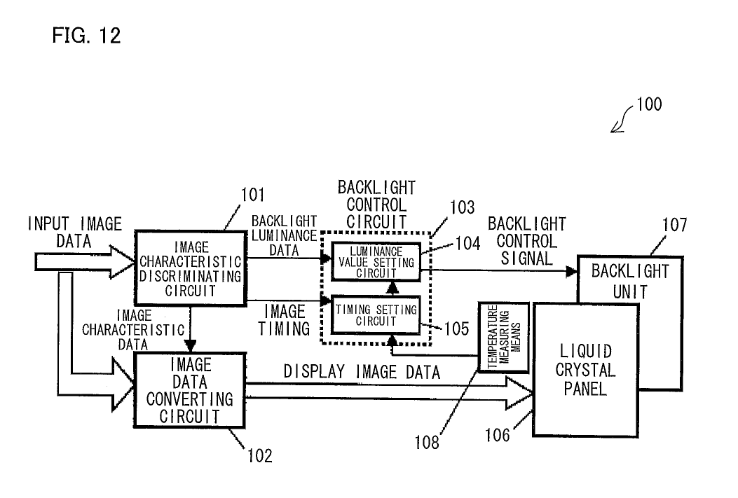

A display control apparatus 1 has an arrangement such that a luminance of a BL unit (backlight) 2 which emits light to a liquid crystal display panel and a tone distribution setting of the liquid crystal display panel are changed in accordance with a tone distribution of an image to be displayed. Note here that the BL unit may include a backlight driver (see FIG. 11).

More specifically, the display control apparatus 1 mainly includes a first dimming process section 3 and a second dimming process section 4. The first dimming process section 3 controls the BL unit 2 by the first dimming process, and the second dimming process section 4 determines the tone distribution setting of the liquid crystal display panel by the second dimming process.

A temperature measuring section 5 is provided outside the display control apparatus 1. The temperature measuring section 5 directly or indirectly measures a surface temperature of the liquid crystal display panel. Information as to a temperature measured by the temperature measuring section 5 is transmitted to each of the first dimming process section 3 and the second dimming process section 4 via a measured temperature information transmitting section 6. Note that an arrangement such that an output of the measured temperature information transmitting section 6 is connected only to the second dimming process section 4 also serves as an embodiment of the present invention.

Note that a temperature sensor constituting the temperature measuring section 5 may be provided on a surface of the liquid crystal display panel or in the liquid crystal display panel, so as to directly measure a temperature of the liquid crystal display panel. Alternatively, the temperature sensor may be provided in a housing of the liquid crystal display panel and set to measure an ambient temperature of the liquid crystal display panel, so as to indirectly measure the temperature of the liquid crystal display panel.

In accordance with the temperature of the liquid crystal display panel which temperature has been obtained via the temperature measuring section 5, the first dimming process section 3 controls the BL luminance dimming period containing the start timing and the processing time of the first dimming process.

In accordance with the temperature of the liquid crystal display panel which temperature has been obtained via the temperature measuring section 5, the second dimming process section 4 controls the tone distribution setting dimming period containing the start timing and the processing time of the second dimming process.

### Specific Arrangement of the Display Control Apparatus

The first dimming process section 3 includes a BL luminance dimming period determining section 31 and a BL luminance control section 32.

The second dimming process section 4 includes a tone distribution setting dimming period determining section 41 and a tone distribution setting control section 42.

The display control apparatus 1 further includes an input image analyzing section 7, an input image determining section 8, a BL luminance level determining section 9, and a tone distribution setting determining section 10.

Note that the BL luminance control section 32 has an output which is connected to the BL unit 2 and the tone distribution setting control section 42 has an output which is connected to a source driver output section 11 that supplies a source signal to the liquid crystal display panel.

### Flow of Data in the Display Control Apparatus

First, the input image analyzing section 7 receives image data for an image to be displayed in a liquid crystal display panel. The input image analyzing section 7 analyzes the received image data by, for example, finding, for all the pixels, integrated values of or average values of respective R (red), G (green), and B (blue) tones.

The input image analyzing section 7 has an output which is connected to the input image determining section 8. In response to a result of the analysis by the input image analyzing section 7, the input image determining section 8 determines what the image to be displayed in the liquid crystal display panel is like.

The image determining section 8 has an output which is connected to each of the BL luminance level determining section 9 and the tone distribution setting determining section 10. Note that in order to further enhance accuracy of the display control method of the present invention, the image determining section 8 may have an output which is connected to each of the BL luminance dimming period determining section 31 and the tone distribution setting dimming period determining section 41. The enhancement of accuracy is described later.

In response to a result of the determination by the image determining section 8, the BL luminance level determining section 9 determines, in accordance with the received image data, i.e., a tone distribution of the image to be displayed, at what level to set the BL luminance level.

In response to the result of the determination by the image determining section 8, the tone distribution setting determining section 10 determines, in accordance with the tone distribution of the image to be displayed, at what level to set the tone distribution setting.

The BL luminance dimming period determining section 31 which is arranged to receive an output of the measured temperature information transmitting section 6 sets the BL luminance dimming period in accordance with the temperature measured by the temperature measuring section 5. Note that the BL luminance dimming period determining section 31 may also set the BL luminance dimming period in accordance with the result of the determination by the image determining section 8. Alternatively, regardless of the result of the determination, the BL luminance dimming period determining section 31 can set the BL luminance dimming period merely in accordance with the temperature. The BL luminance dimming period determining section 31 can also set the BL luminance dimming period in accordance with both a result of the determination of the image and a result of the measurement of the temperature.

The tone distribution setting dimming period determining section 41 sets the tone distribution setting dimming period in accordance with the temperature measured by the temperature measuring section 5. Note that the tone distribution setting dimming period determining section 41 may also set the tone distribution setting dimming period in accordance with the result of the determination by the image determining section 8.

Alternatively, regardless of the result of the determination, the tone distribution setting dimming period determining section 41 can set the tone distribution setting dimming period merely in accordance with the temperature. The tone distribution setting dimming period determining section 41 can also set the tone distribution setting dimming period in accordance with both the result of the determination of the image and the result of the measurement of the temperature.

The BL luminance level determining section 9 and the BL luminance dimming period determining section 31 have respective outputs each of which is connected to the BL luminance control section 32. The BL luminance control section 32 actually controls a level of the BL luminance for each frame in accordance with information obtained from each of the BL luminance level determining section 9 and the BL luminance dimming period determining section 31.

More specifically, in a case where a tone distribution of an image to be displayed changes, the BL luminance level determining section 9 outputs, for example, information as to a luminance change from the luminance Γ′1 to the luminance Γ′2 in response to the tone distribution obtained before and after the change. The BL luminance control section 32 controls the level of the BL luminance for each frame so that the BL luminance changes from the luminance Γ′1 to the luminance Γ′2 in the BL luminance dimming period determined by the BL luminance dimming period determining section 31.

In accordance with information from the BL luminance control section 32 as to the level of the BL luminance, the BL unit 2 changes the luminance of the backlight constituted by an LED (Light Emitting Diode) or a CCFL (Cold Cathode Fluorescent Lamp).

The tone distribution setting determining section 10 and the tone distribution setting dimming period determining section 41 have respective outputs each of which is connected to the tone distribution setting control section 42. The tone distribution setting control section 42 actually controls a tone distribution setting (actual γ) for each frame in accordance with information obtained from each of the tone distribution setting determining section 10 and the tone distribution setting dimming period determining section 41.

More specifically, in a case where a tone distribution of an image to be displayed changes, the tone distribution setting determining section 10 outputs, for example, information as to a change from the level 1 to the level 2 in response to the tone distribution obtained before and after the change. The tone distribution setting control section 42 controls the tone distribution setting for each frame so that the tone distribution setting changes from the level 1 to the level 2 in the tone distribution setting dimming period determined by the tone distribution setting dimming period determining section 41.

### Arrangement of the Display Control Apparatus Not Carrying out Temperature-based Display Control

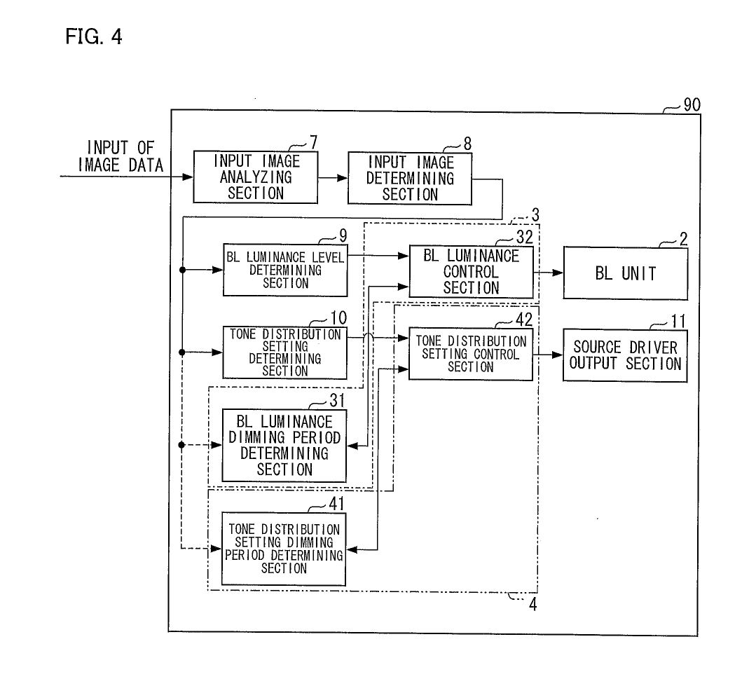

For reference, FIG. 4 shows an arrangement of a display control apparatus 90 which does not carry out temperature-based display control. The display control apparatus 90 is different from the display control apparatus 1 merely in that the display control apparatus 90 includes no temperature measuring section 5 and no measured temperature information transmitting section 6.

The following description more specifically discusses the display control method of the present invention.

### EXAMPLE 1-1

### Determination of Dimming Period and Display Control

First, the input image analyzing section 7 receives image data for the image A (a low tone) to be displayed in the liquid crystal display panel as the frame n (see FIG. 1). The input image analyzing section 7 analyzes the received image data and supplies a result of the analysis to the input image determining section 8 (described earlier). In response to the result of the analysis by the input image analyzing section 7, the input image determining section 8 determines that the image A is a dark image. Then, the input image determining section 8 supplies a result of the determination to each of the BL luminance level determining section 9 and the tone distribution setting determining section 10.

According to this, the BL luminance level determining section 9 determines that the level of the BL luminance in accordance with the low tone of the image A is the luminance Γ1, and the tone distribution setting determining section 10 determines that the level of the tone distribution setting in accordance with the low tone of the image A is the level 1. Information of the luminance Γ′1 thus determined is supplied to the BL luminance control section 32, and information of the level 1 thus determined is supplied to the tone distribution setting control section 42.

Subsequently, in a case where the input image analyzing section 7 receives image data for the image B (a high tone) to be displayed as the frame (n+1), as in the case of the image A, the BL luminance level determining section 9 determines that the level of the BL luminance in accordance with the high tone of the image B is the luminance Γ′2, and the tone distribution setting determining section 10 determines that the level of the tone distribution setting in accordance with the high tone of the image B is the level 2. Information of the luminance Γ2 thus determined is supplied to the BL luminance control section 32, and information of the level 2 thus determined is supplied to the tone distribution setting control section 42.

Note that the level of the BL luminance and the level of the tone distribution setting are associated with each other in multistages as described with reference to FIG. 13. Therefore, the level of the BL luminance and the level of the tone distribution setting thus associated with each other are appropriately selected in accordance with a brightness of the image data determined by the image analyzing section 7.

The BL luminance control section 32 which has recognized a change in level of the BL luminance in accordance with a change in tone distribution as described above requests the BL luminance dimming period determining section 31 to set the BL luminance dimming period in accordance with the current temperature. Note that according to an embodiment in which setting of the BL luminance dimming period in accordance with the current temperature is not carried out, the BL luminance dimming period set for the normal temperature is not changed.

Similarly, the tone distribution setting control section 42 which has recognized a change in level of the tone distribution setting in accordance with the change in tone distribution as described above requests the tone distribution setting dimming period determining section 41 to set the tone distribution setting dimming period in accordance with the current temperature.

In response to the request, the BL luminance dimming period determining section 31 determines, as described earlier, that the BL luminance dimming period in accordance with the current temperature measured by the temperature measuring section 5 is (m−1) frame periods (see an example shown in FIG. 1). Similarly, the tone distribution setting dimming period determining section 41 determines, as described earlier, that the tone distribution setting dimming period in accordance with the current temperature is (m−k−1) frame periods. The (m−k−1) frame periods, which are determined in accordance with the current temperature of the liquid crystal display panel lower than the normal temperature, are set to be shorter than the BL luminance dimming period.

The BL luminance control section 32 actually controls the level of the BL luminance for each frame gradually or in stages in accordance with the information received from the BL luminance level determining section 9 as to each of the luminance Γ1 and the luminance Γ2 and information received from the BL luminance dimming period determining section 31 as to the (m−1) frame periods. Namely, the BL luminance control section 32 controls the luminance of the BL unit 2 so that the luminance of the BL unit 2 is maintained at the luminance Γ′1 in the frame (n+1), starts rising in the frame (n+2), and reaches the luminance Γ′2 in the frame (n+m).

Similarly, the tone distribution setting control section 42 actually controls the level of the tone distribution setting for each frame gradually or in stages in accordance with the information received from the tone distribution setting determining section 10 as to each of the level 1 and the level 2 and information received from the tone distribution setting dimming period determining section 41 as to the (m−k−1) frame periods. Namely, the tone distribution setting control section 42 controls an image data conversion process of the source driver output section 11 so that the tone distribution setting is maintained at the level 1 in the frame (n+1), starts changing in the frame (n+2), and reaches the level 2 in the frame (n+m−k+1).

Note that the BL luminance dimming period determining section 31 and the tone distribution setting dimming period determining section 41 may set the respective dimming periods in response to the result of the determination by the input image determining section 8. Such a method makes it possible to carry out a dimming process which is finely tuned to a rate of change in tone distribution.

### Temperature Comparison between Dimming Periods

FIG. 2 shows a specific example of the CABC technique carried out at a normal temperature. In a case where the current temperature of the liquid crystal display panel is the normal temperature, each of the BL luminance dimming period and the tone distribution setting dimming period is set to be (m−1) frame periods. That is, at the normal temperature, the tone distribution setting dimming period is adjusted so that a change in liquid crystal and a change in backlight luminance finish at substantially identical timings.

According to a comparison between the dimming period at the low temperature (see FIG. 1) and the dimming period at the normal temperature (see FIG. 2), the BL luminance dimming period at the low temperature is identical to that at the normal temperature, whereas the tone distribution setting dimming period at the low temperature is shorter than that at the normal temperature.

In other words, since the level of the BL luminance and the level of the tone distribution setting do not change in accordance with the temperature before and after the dimming process is carried out, a rate (rate of change) at which to change the BL luminance at the low temperature is identical to the rate at the normal temperature, whereas a rate (rate of change) at which to change the tone distribution setting at the temperature lower than the normal temperature is higher than the rate at the normal temperature. The reason for this is described below.

First, the BL luminance dimming period at the low temperature is identical to that at the normal temperature due to the following reason. It is necessary to accelerate the change in tone distribution setting at the low temperature since a liquid crystal responds slower at the low temperature than at the normal temperature. In contrast, it is unnecessary to cause the backlight luminance to change in a shorter time since the backlight luminance time hardly depends on an ambient temperature. Namely, even in order to cause the change in tone distribution setting to respond to the slow liquid crystal response by accelerating the change in tone distribution setting at the low temperature, it is unnecessary to finish a change in display at the low temperature as early as or earlier than at the normal temperature. Accordingly, since the change in display at the low temperature and the change in display at the normal temperature are finished at substantially identical timings, it is basically unnecessary to cause the backlight luminance to change in a shorter time.

In contrast, since a liquid crystal responds slower at the low temperature than at the normal temperature, it is impossible for the liquid crystal to finish changing during the dimming period at the normal temperature. As a result, the change in liquid crystal is finished after the end of the dimming period. That is, there occurs a difference between a timing at which the change in backlight luminance is finished and a timing at which the change in liquid crystal is finished, the difference hardly occurring at the normal temperature. Therefore, an appearance of an image to be displayed in the liquid crystal display panel is influenced by a flicker and/or a luminance change.

In order to avoid such an influence, it is necessary to finish the change in liquid crystal early at the low temperature. Therefore, the tone distribution setting dimming period is set to be short (the rate of change of the tone distribution setting is set to be high).

According to this, also at the low temperature, it is possible to display, in the liquid crystal display panel, a high quality image which is identical to that displayed at the normal temperature.

Note that, in a case where the BL luminance dimming period and the tone distribution setting dimming period are controlled at the low temperature as described above, the tone distribution setting dimming period is shorter than the BL luminance dimming period at the low temperature.

Assume that the BL luminance dimming period and the tone distribution setting dimming period are set to be equal at the low temperature. In this case, for appearance, a change in tone distribution characteristic is visible after the BL luminance has changed. This causes human eyes to sense a difference between the change in BL luminance and the change in tone distribution characteristic, so that the human eyes cannot sense an image quality which is identical to that sensed at the normal temperature.

In view of the problems, in a case where the tone distribution setting dimming period is controlled to be shorter than the BL luminance dimming period at the temperature lower than the normal temperature, the change in tone distribution setting occurs faster than the change in backlight luminance. This can solve the problems.

Note that it is preferable that the tone distribution setting dimming period be not less than 2 frame periods.

### EXAMPLE 1-2

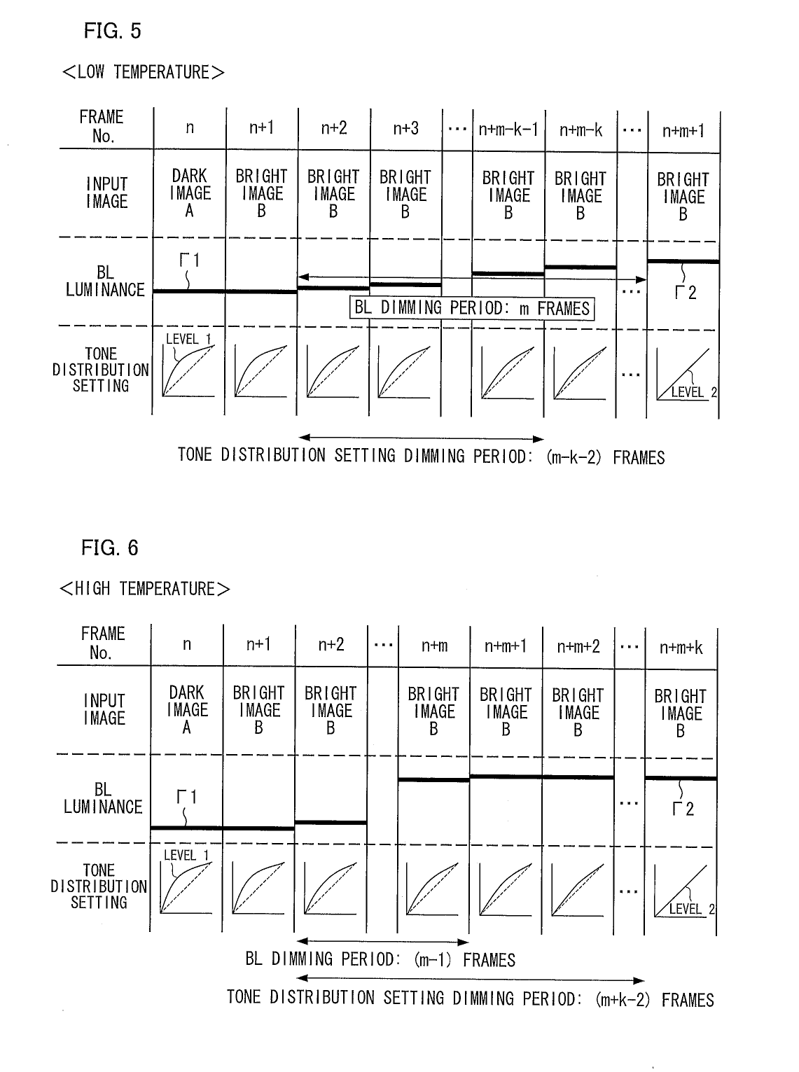

FIG. 5 shows another specific example of the CABC technique carried out at the low temperature in accordance with the display control method of the present invention.

Example 1-1 focuses on the point that the tone distribution setting dimming period at the low temperature is controlled to be shorter than that at the normal temperature. The present example is further characteristic in that the BL luminance dimming period at the low temperature is controlled to be longer than that at the normal temperature.

More specifically, the BL luminance dimming period is set to be longer than that shown in FIG. 2, and is set to be (m) frame periods, so that the BL luminance dimming period is set to be longer by, for example, one (1) frame period than the BL luminance dimming period at the normal temperature (see FIG. 5).

This is because of the following reason. In particular, at the low temperature, a tone distribution characteristic (liquid crystal) changes more slowly in accordance with a lower liquid crystal response speed. Therefore, even if the tone distribution setting dimming period is set to be shorter than that at the normal temperature (see Example 1-1), the change in liquid crystal may not be finished before the BL luminance dimming period at the normal temperature is ended. Accordingly, control shown in FIG. 5 allows the change in liquid crystal to be finished without fail before the BL luminance dimming period is ended, so that a high image quality can be secured.

Note that it is preferable to set the BL luminance dimming period at the temperature lower than the normal temperature to be longer, by one (1) frame to five frames, than the BL luminance dimming period set at the normal temperature. The tone distribution setting dimming period (m−k−2), which is shorter, by one (1) frame period, than that shown in Example 1-1, is merely shown as an example. It is preferable that the tone distribution setting dimming period (m−k−2) be shorter than the BL luminance dimming period.

### EXAMPLE 1-3

### Dimming Period at High Temperature

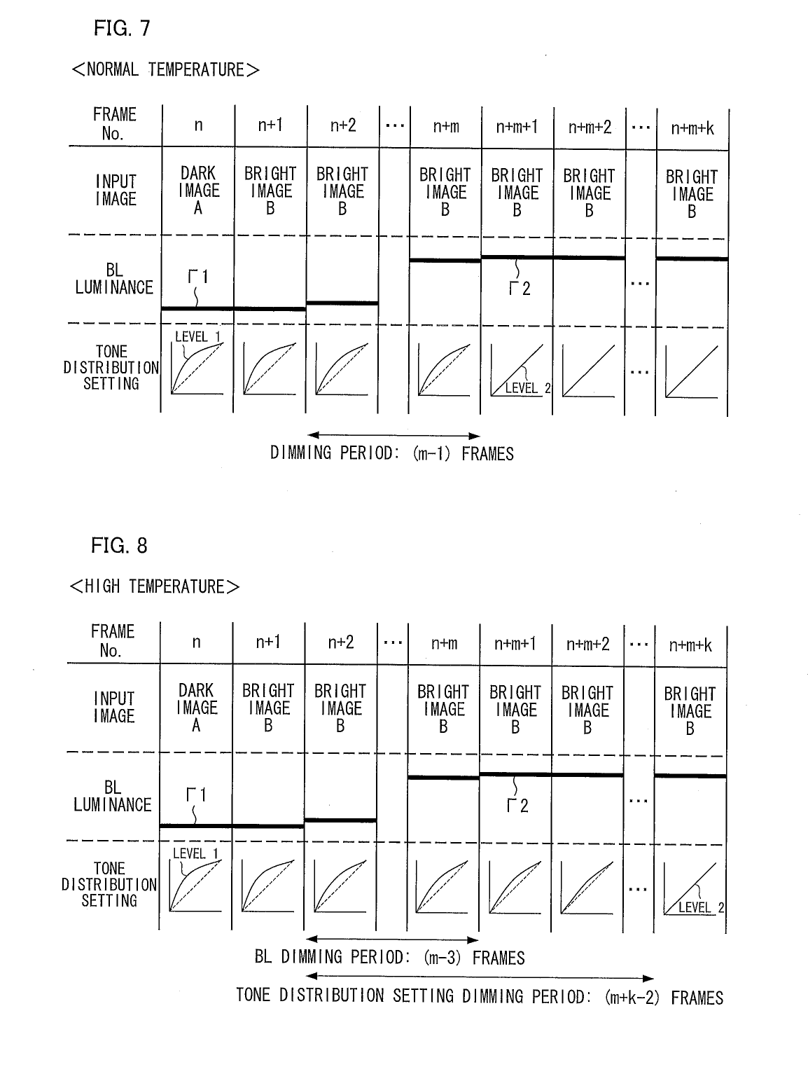

FIG. 6 shows a specific example of the CABC technique carried out at a high temperature in accordance with the display control method of the present invention. FIG. 7 shows a specific example of the CABC technique carried out at the normal temperature. FIG. 7, which is identical to FIG. 2 in contents, is shorter in transverse axis (temporal axis) than FIG. 2.

In a case where the image has been changed from the dark image A of the frame n to the bright image B and then it is detected that the temperature of the liquid crystal display panel is higher than the normal temperature, as in the case of the normal temperature, the BL luminance is maintained at the luminance Γ′1 in the frame (n+1), starts rising in the frame (n+2), and reaches the luminance Γ′2 in a frame (n+m+1) (see FIG. 6). Therefore, the BL luminance changes from the luminance Γ′1 to the luminance Γ′2 in (m−1) frame periods.

Meanwhile, the tone distribution setting is maintained at the level 1 in the frame (n+1), starts changing in the frame (n+2), and reaches the level 2 in a frame (n+m+k). Therefore, the tone distribution setting dimming period, which is (m+k−2) frame periods, is set to be longer than the BL luminance dimming period.

### Temperature Comparison between Dimming Periods

According to a comparison between the tone distribution setting dimming period at the high temperature (see FIG. 6) and the tone distribution setting dimming period at the normal temperature (see FIG. 7), the tone distribution setting dimming period at the high temperature is longer than that at the normal temperature.

In other words, since the level of the BL luminance and the level of the tone distribution setting do not change in accordance with the temperature before and after the dimming process is carried out, a rate (rate of change) at which to change the tone distribution setting at the temperature higher than the normal temperature is lower than the rate at the normal temperature. The reason for this is described below.

Since a liquid crystal responds faster at the high temperature than at the normal temperature, the change in liquid crystal is finished before the end of the dimming period at the normal temperature. That is, there occurs a difference between a timing at which the change in backlight luminance is finished and a timing at which the change in liquid crystal is finished, the difference hardly occurring at the normal temperature. Therefore, an appearance of an image to be displayed in the liquid crystal display panel is influenced by a flicker and/or a luminance change.

In order to avoid such an influence, it is necessary to finish the change in liquid crystal late at the high temperature. Therefore, the tone distribution setting dimming period is set to be long (the rate of change of the tone distribution setting is set to be low).

Note that a liquid crystal response speed is approximately 0.4 to 0.5 times higher at the high temperature than that at the normal temperature. Therefore, it is preferable that the tone distribution setting dimming period at the high temperature be not more than three times longer than the tone distribution setting dimming period set at the normal temperature.

The tone distribution setting dimming period and the BL luminance dimming period are equal at the normal temperature. Therefore, it can also be said that the tone distribution setting dimming period at the high temperature be not more than three times longer than the BL luminance dimming period set at the normal temperature.

According to this, also at the high temperature, it is possible to display, in the liquid crystal display panel, a high quality image which is identical to that displayed at the normal temperature.

### EXAMPLE 1-4

FIG. 8 shows another specific example of the CABC technique carried out at the high temperature in accordance with the display control method of the present invention.

Example 1-3 focuses on the point that the tone distribution setting dimming period at the high temperature is controlled to be longer than that at the normal temperature. The present example is further characteristic in that the BL luminance dimming period at the high temperature is controlled to be shorter than that at the normal temperature.

More specifically, the BL luminance dimming period is set to be shorter than that shown in FIG. 7, and is set to be (m−3) frame periods, so that the BL luminance dimming period is set to be shorter by, for example, two frame periods than the BL luminance dimming period at the normal temperature (see FIG. 8).

This is because of the following reason. In particular, at the high temperature, a tone distribution characteristic (liquid crystal) changes faster in accordance with a higher liquid crystal response speed. Therefore, even if the tone distribution setting dimming period is set to be longer than that at the normal temperature (see Example 1-3), the change in liquid crystal may be finished before the BL luminance dimming period at the normal temperature is ended. Accordingly, control shown in FIG. 8 allows the BL luminance dimming period and the change in liquid crystal to be finished substantially simultaneously as in the case of the normal temperature, so that a high image quality can be obtained.

Note that it is preferable to set the BL luminance dimming period at the high temperature to be shorter, by one (1) frame to five frames, than the BL luminance dimming period set at the normal temperature.

### Embodiment 2

### Point of Change in Display Control Method

According to Examples 1-1 through 1-3, the BL luminance dimming period and the tone distribution setting dimming period are set to start simultaneously. In contrast, the present example discusses display control for causing a tone distribution setting dimming period to start earlier than a BL luminance dimming period.

### Arrangement of Display Control Apparatus

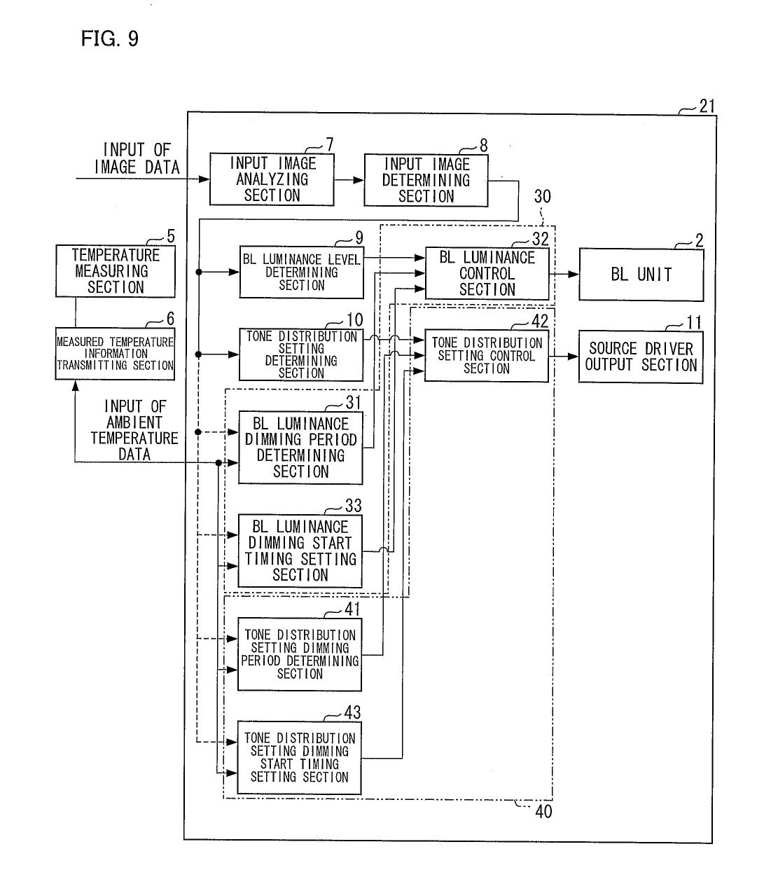

FIG. 9 is a block diagram showing another arrangement example of a display control apparatus in accordance with the present invention. A display control apparatus 21 of the present embodiment is different from the display control apparatus 1 in that the display control apparatus 21 includes a first dimming process section 30 and a second dimming process section 40 which correspond to the first dimming process section 3 and the second dimming process section 4, respectively.

The first dimming process section 30 includes not only a BL luminance dimming period determining section 31 and a BL luminance control section 32 (which are described earlier) but also a BL luminance dimming start timing setting section (first start timing setting section) 33 which sets a start timing of a first dimming process in accordance with a temperature of a liquid crystal display panel which temperature has been obtained via a temperature measuring section 5.

The second dimming process section 40 includes a tone distribution setting dimming start timing setting section (second start timing setting section) 43 which sets a start timing of a second dimming process in accordance with the temperature of the liquid crystal display panel which temperature has been obtained via the temperature measuring section 5 (described earlier).

Note that each of the BL luminance dimming start timing setting section 33 and the tone distribution setting dimming start timing setting section 43 may receive a result of determination by an input image determining section 8 and the BL luminance dimming start timing setting section 33 and the tone distribution setting dimming start timing setting section 43 may set the respective start timings in response to the result of the determination. This makes it possible to carry out a dimming process which is finely tuned to a rate of change in tone distribution.

### Setting of Dimming Start Timing

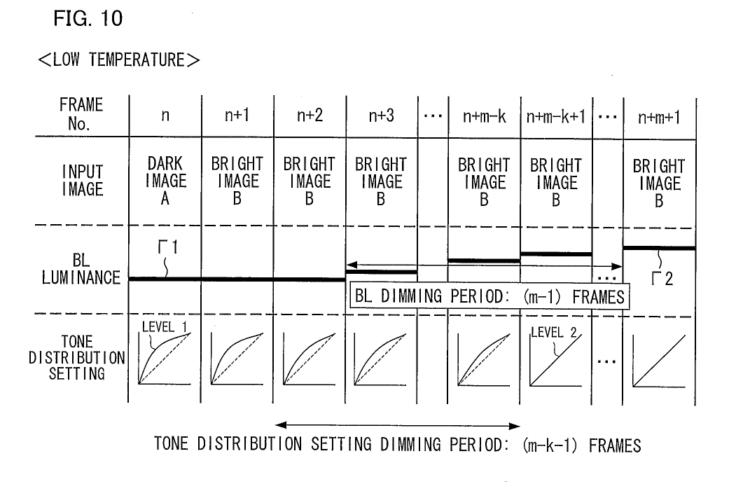

FIG. 10 shows a display control method for adjusting a BL luminance dimming period start timing and a tone distribution setting dimming period start timing.

In a case where the temperature of the liquid crystal display panel is lower than a normal temperature, the BL luminance dimming start timing setting section 33 and the tone distribution setting dimming start timing setting section 43 (which are shown in FIG. 9) set the respective dimming period start timings so that the tone distribution setting dimming period start timing is earlier than the BL luminance dimming period start timing (see FIG. 10).

More specifically, in a case where a dark image A of a frame n has been changed to a bright image B of a frame (n+1), a BL luminance is maintained at a luminance Γ′1 until the end of a frame (n+2), starts rising in a frame (n+3), and reaches a luminance Γ′2 in a frame (n+m+1). Therefore, a BL luminance dimming period, which is identical to that at the normal temperature, is (m−1) frame periods. Note that the BL luminance dimming period may be set to be longer than that at the normal temperature.

Meanwhile, a tone distribution setting is maintained at a level 1 until the end of the frame (n+1), starts changing in the frame (n+2), which is one (1) frame earlier than the BL luminance, and reaches a level 2 in a frame (n+m−k+1). Accordingly, a tone distribution setting dimming period, which is (m−k) frame periods, is set to be shorter than that at the normal temperature.

As described earlier, a rate of change in tone distribution characteristic (referring to a characteristic which is determined by a tone distribution setting and is visible to humans) refers to a temperature dependence, and a change in tone distribution characteristic occurs slowly at the low temperature. Therefore, in a case where the first dimming process and the second dimming process are set to start simultaneously, the change in tone distribution characteristic may not catch up with a change in backlight luminance. As a result, there seems to occur a problem such that in appearance, the BL luminance changes earlier and then the tone distribution characteristic changes later.

In view of the circumstances, it is possible to prevent occurrence of the problem by controlling the start timing of the second dimming process to be earlier than the start timing of the first dimming process.

Note that it is preferable to set, at the low temperature, the start timing of the second dimming process to be earlier, by one (1) frame to five frames, than the start timing of the first dimming process. A comparison of BL luminance dimming start timings between FIGS. 2 and 10 shows that the BL luminance dimming start timing shown in FIG. 10 and set at the low temperature is later than that shown in FIG. 2. This point has no particular meaning. For example, in a case where at the normal temperature, both the BL luminance dimming period and the tone distribution setting dimming period start in a frame (n+5), at the low temperature, the BL luminance dimming period may start in the frame (n+5), and the tone distribution setting dimming period may start in the frame (n+2).

Note that a liquid crystal responds fast at the high temperature. Therefore, display control may be carried out so that the tone distribution setting dimming period start timing is later than the BL luminance dimming period start timing (e.g., by one (1) frame to five frames). This allows a change in BL luminance and a liquid crystal response to be finished at identical timings.

Note that it is preferable to set, at the high temperature, the tone distribution setting dimming period to be longer than that at the normal temperature by setting the BL luminance dimming period to be equal to or shorter than that at the normal temperature.

### Arrangement of Liquid Crystal Display Apparatus

Finally, an arrangement of a liquid crystal display apparatus including a display control apparatus which operates in accordance with a display control program. FIG. 11 is a block diagram schematically showing an overall arrangement of a liquid crystal display apparatus in accordance with the present invention.

The liquid crystal display apparatus in accordance with the present invention includes not only the display control apparatus 1 or 21, the temperature measuring section 5, and the measured temperature information transmitting section (which are described earlier) but also a CPU 50, an input/output interface 51, a ROM 52, a RAM 53, a liquid crystal driver 54, a liquid crystal display panel 55, a backlight driver 56 and a backlight 57 each constituting the BL unit 2, and an image data process section 58.

The CPU 50 reads a control program stored in the ROM (a computer-readable recording medium), and integratedly controls an input/output of various pieces of data and various control signals in the liquid crystal display apparatus in accordance with the control program while using the RAM 53 as a work area.

The image data process section 58 which has received image data via a communication section connected to a television tuner or the Internet carries out various processes such as a sync signal generation process, a luminance and chroma adjustment process, and a tone distribution correction, and then generates an RGB signal.

The CPU 50 receives the RGB signal generated by the image data process section 58. Then, together with a sync signal which is necessary, the RGB signal is supplied to the display control apparatus 1 or 21 via the input/output interface 51.

The display control apparatus 1 or 21 carries out the tone distribution setting dimming process (described earlier) with respect to the RGB signal. Then, the display control apparatus 1 or 21 supplies, to the liquid crystal driver 54, the sync signal and the RGB signal which has been subjected to the tone distribution setting dimming process. The display control apparatus 1 or 21 also supplies, to the backlight driver 56, the sync signal and BL luminance data generated in accordance with the RGB signal.

The liquid crystal driver 54, which includes the source driver output section 11 and a gate driver output section, drives each pixel of the liquid crystal display panel in accordance with the RGB signal and the sync signal which have been supplied from the display control apparatus 1 or 21.

The backlight driver 56 controls a luminance of the backlight 57 for each frame in accordance with the BL luminance data supplied from the display control apparatus 1 or 21.

The current temperature of the liquid crystal display panel 55 which temperature has been measured by the temperature measuring section 5 is transmitted from the measured temperature information transmitting section 6 to the display control apparatus 1 or 21.

The liquid crystal display apparatus in accordance with the present invention does not necessarily need to include the CPU 50, the input/output interface 51, the ROM 52, and the RAM 53. Namely, the liquid crystal display apparatus in accordance with the present invention may be arranged to include not only the display control apparatus 1 or 21, the temperature measuring section 5, and the measured temperature information transmitting section 6 (which are described earlier) but also the liquid crystal driver 54, the liquid crystal display panel 55, the backlight driver 56 and the backlight 57 each constituting the BL unit 2, and the image data process section 58.

As described earlier, according to a display control method in accordance with the present invention, in a case where an image to be displayed changes in tone between two successive frames (n and (n+1)), (i) a first dimming process for changing a luminance of a backlight from a luminance Γ1 to a luminance Γ2 and a second dimming process for changing a tone distribution setting from a level 1 to a level are carried out in a plurality of frame periods in accordance with tones obtained before and after the change, and (ii) at least a second dimming period containing a start timing and a processing time of the second dimming process is controlled in accordance with a temperature of a liquid crystal display panel.

This makes it possible to provide a liquid crystal display apparatus including a backlight with a technique for carrying out high image quality display control in accordance with a tone of an image to be displayed and a temperature of a liquid crystal display panel.

The display control method in accordance with the present invention is preferably arranged such that the processing time of the second dimming process carried out at the temperature lower than a normal temperature is controlled to be shorter than the processing time of the second dimming process carried out at the normal temperature.

In other words, it is preferable that a rate (rate of change) at which to change the tone distribution setting at the temperature lower than the normal temperature be higher than the rate at the normal temperature.

Since a liquid crystal responds slower at the low temperature than at the normal temperature, it is impossible for the liquid crystal to finish changing during the tone distribution change time at the normal temperature. In contrast, a luminance change period of a backlight unit using, for example, an LED is independent of a temperature. As a result, the change in liquid crystal is finished after the end of the backlight luminance change time. That is, there occurs a difference between a timing at which the change in backlight luminance is finished and a timing at which the change in liquid crystal is finished, the difference hardly occurring at the normal temperature. Therefore, an appearance of an image to be displayed in the liquid crystal display panel is influenced by a flicker and/or a luminance change.

In order to avoid such an influence, it is necessary to finish the change in liquid crystal early at the low temperature. Therefore, the tone distribution change time is set to be short (the rate of change of the tone distribution setting is set to be high). According to this, also at the low temperature, it is possible to obtain an image quality which is identical to that obtained at the normal temperature.

The display control method in accordance with the present invention is preferably arranged such that the processing time of the second dimming process carried out at the temperature higher than the normal temperature is controlled to be longer than the processing time of the second dimming process carried out at the normal temperature.

In other words, it is preferable that a rate (rate of change) at which to change the tone distribution setting at the temperature higher than the normal temperature be lower than the rate at the normal temperature.

Since a liquid crystal responds faster at the high temperature than at the normal temperature, the change in liquid crystal in response to an applied voltage is finished before the end of the tone distribution change time at the normal temperature. This causes a difference between a timing at which the change in backlight luminance is finished and a timing at which the change in liquid crystal is finished, the difference hardly occurring at the normal temperature. As a result, an appearance of an image to be displayed in the liquid crystal display panel is influenced by a flicker and/or a luminance change.

In order to avoid such an influence, it is necessary to finish the change in liquid crystal late at the high temperature. Therefore, the tone distribution change time is set to be long (the rate of change of the tone distribution setting is set to be low). According to this, also at the high temperature, it is possible to obtain an image quality which is identical to that obtained at the normal temperature.

The display control method in accordance with the present invention is preferably arranged such that at the temperature lower than the normal temperature, the processing time of the second dimming process is controlled to be shorter than a processing time of the first dimming process.

The display control method in accordance with the present invention is preferably arranged such that at the temperature higher than the normal temperature, the processing time of the second dimming process is controlled to be longer than the processing time of the first dimming process.

According to the method, changing the tone distribution setting is substantially identical to changing a transmittance of a pixel by adjusting a voltage to be applied to the pixel so that an output tone changes in response to a given input tone. In this case, a rate of change in transmittance of the pixel in response to a change in voltage to be applied to the pixel (liquid crystal responsiveness) shows a temperature dependence. Therefore, a rate of change in tone distribution characteristic due to the change in tone distribution setting also shows a temperature dependence. Namely, the rate of change in tone distribution characteristic is low at the low temperature, whereas the rate of change in tone distribution characteristic is high at the high temperature.

Therefore, in a case where a rate of change in backlight luminance which rate shows no temperature dependence and a rate of change in tone distribution characteristic which rate shows a temperature dependence are set to be equal to each other, i.e., in a case where the first dimming process and the second dimming process are set to be identical in processing time, a change in tone distribution characteristic in accordance with the tone distribution setting occurs at a high or low speed. This causes human eyes to sense a difference between the change in backlight luminance and the change in tone distribution characteristic, so that the human eyes cannot sense an image quality which is identical to that sensed at the normal temperature.

At the low temperature, since the change in tone distribution characteristic does not catch up with the change in backlight luminance, it is impossible to obtain an image quality which is identical to that obtained at the normal temperature. On the contrary, at the high temperature, since the change in tone distribution characteristic passes the change in backlight luminance, it is impossible to obtain an image quality which is identical to that obtained at the normal temperature. Such problems as described above cannot be ignored from the viewpoint of achieving a high image quality.

In view of the circumstances, assume that at the temperature lower than the normal temperature, the processing time of the second dimming process is controlled to be shorter than the processing time of the first dimming process (note, however, that the processing time of the second dimming process is not less than two frames), and at the temperature higher than the normal temperature, the processing time of the second dimming process is controlled to be longer than the processing time of the first dimming process. In this case, a state in which the change in tone distribution characteristic is finished and the change in backlight luminance is finished can be identical to the state at the normal temperature. This makes it possible to solve the problems.

The display control method in accordance with the present invention is preferably arranged such that at the temperature lower than the normal temperature, the start timing of the second dimming process is controlled to be earlier than a start timing of the first dimming process.

As described earlier, the rate of change in tone distribution characteristic shows a temperature dependence, and the change in tone distribution characteristic occurs slowly at the low temperature.

Therefore, in a case where the first dimming process and the second dimming process are set to start simultaneously, the change in tone distribution characteristic does not catch up with the change in backlight luminance. This causes a problem such that it is impossible to obtain an appearance which is identical to that obtained at the normal temperature.

In view of the circumstances, it is possible to solve the problem by controlling the start timing of the second dimming process to be earlier than the start timing of the first dimming process.

The display control method in accordance with the present invention is preferably arranged such that at the temperature higher than the normal temperature, the start timing of the second dimming process is controlled to be later than the start timing of the first dimming process.

As described earlier, contrary to the case of the low temperature, the change in tone distribution characteristic occurs fast at the high temperature. Therefore, in a case where the first dimming process and the second dimming process are set to start simultaneously, the change in tone distribution characteristic is finished earlier than the change in backlight luminance. This causes a problem such that it is impossible to obtain an appearance which is identical to that obtained at the normal temperature.

In view of the circumstances, in a case where the start timing of the second dimming process is set to be later than the start timing of the first dimming process, the change in backlight luminance and the change in tone distribution characteristic can be set to be finished simultaneously. This makes it possible to solve the problem.

The display control method in accordance with the present invention is preferably arranged such that the processing time of the first dimming process carried out at the temperature lower than the normal temperature is controlled to be not less than the processing time of the first dimming process carried out at the normal temperature.

The display control method in accordance with the present invention is preferably arranged such that the processing time of the first dimming process carried out at the temperature higher than the normal temperature is controlled to be not more than the processing time of the first dimming process carried out at the normal temperature.

The rate of change in backlight luminance shows no temperature dependence. Therefore, even if the temperature is changed, it is basically unnecessary to change the processing time of the first dimming process carried out at the normal temperature.

However, as described earlier, at the low temperature, the processing time of the second dimming process is preferably controlled to be shorter than the processing time of the first dimming process. On the contrary, at the high temperature, the processing time of the second dimming process is preferably controlled to be longer than the processing time of the first dimming process.

Accordingly, in order to satisfy such conditions as described above, it is preferable that (i) the processing time of the first dimming process carried out at the low temperature be set to be not less than the processing time of the first dimming process carried out at the normal temperature and (ii) the processing time of the first dimming process carried out at the high temperature be set to be not more than the processing time of the first dimming process carried out at the normal temperature.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be suitably used for various types of display apparatuses such as a mobile phone, a PDA, a personal computer including a display, televisions having various sizes, and a projector.

### REFERENCE SIGNS LIST

1 Display control apparatus

2 BL unit (Backlight)

3 First dimming process section

4 Second dimming process section

5 Temperature measuring section

21 Display control apparatus

30 First dimming process section

40 Second dimming process section

52 ROM (Computer-readable recording medium)

55 Liquid crystal display panel

n Frame (First frame)

n+1 Frame (Second frame)

Γ1 Luminance (First luminance)

Γ2 Luminance (Second luminance)

1. A display control method for changing, in accordance with a characteristic of an image to be displayed in a liquid crystal display panel, (i) a luminance of a backlight which emits light to the liquid crystal display panel and (ii) a tone distribution of the image to be displayed in the liquid crystal display panel,
said display control method including:
a first dimming process for, in order to change first image data of a first frame to second image data of a second frame following the first frame, changing, in a backlight luminance change time which is a plurality of frame periods, a first backlight luminance corresponding to the first image data to a second backlight luminance corresponding to the second image data; and
a second dimming process for changing, in a tone distribution change time which is a plurality of frame periods, a first tone distribution setting corresponding to the first image data to a second tone distribution setting corresponding to the second image data,
said display control method comprising the step of:
controlling, in accordance with a temperature of the liquid crystal display panel, at least the second dimming period which contains a start timing and a processing time of the second dimming process.

2. The display control method as set forth in claim 1, wherein the processing time of the second dimming process carried out at the temperature lower than a normal temperature is controlled to be shorter than the processing time of the second dimming process carried out at the normal temperature.

3. The display control method as set forth in claim 1, wherein the processing time of the second dimming process carried out at the temperature higher than the normal temperature is controlled to be longer than the processing time of the second dimming process carried out at the normal temperature.

4. The display control method as set forth in claim 1, wherein at the temperature lower than the normal temperature, the processing time of the second dimming process is controlled to be shorter than a processing time of the first dimming process.

5. The display control method as set forth in claim 1, wherein at the temperature higher than the normal temperature, the processing time of the second dimming process is controlled to be longer than the processing time of the first dimming process.

6. The display control method as set forth in claim 1, wherein at the temperature lower than the normal temperature, the start timing of the second dimming process is controlled to be earlier than a start timing of the first dimming process.

7. The display control method as set forth in claim 1, wherein at the temperature higher than the normal temperature, the start timing of the second dimming process is controlled to be later than the start timing of the first dimming process.

8. The display control method as set forth in claim 2, wherein the processing time of the first dimming process carried out at the temperature lower than the normal temperature is controlled to be not less than the processing time of the first dimming process carried out at the normal temperature.

9. The display control method as set forth in claim 2, wherein the processing time of the first dimming process carried out at the temperature higher than the normal temperature is controlled to be not more than the processing time of the first dimming process carried out at the normal temperature.

10. A display control apparatus which changes, in accordance with a characteristic of an image to be displayed in a liquid crystal display panel, (i) a luminance of a backlight which emits light to the liquid crystal display panel and (ii) a tone distribution of the image to be displayed in the liquid crystal display panel,
said display control apparatus comprising:
a first dimming process section which controls the luminance of the backlight by carrying out a first dimming process for, in order to change first image data of a first frame to second image data of a second frame following the first frame, changing, in a luminance change time which is a plurality of frame periods, a first luminance corresponding to the first image data to a second luminance corresponding to the second image data; and
a second dimming process section which controls a tone distribution setting of the liquid crystal display panel by carrying out a second dimming process for changing, in a tone distribution change time which is a plurality of frame periods, a first tone distribution setting corresponding to the first image data to a second tone distribution setting corresponding to the second image data,
at least the second dimming process section controlling, in accordance with a temperature of the liquid crystal display panel, a second dimming period containing a start timing and a processing time of the second dimming process, the temperature having been obtained via a temperature measuring section which directly or indirectly measures a temperature of the liquid crystal display panel.

11. A liquid crystal display apparatus comprising the display control apparatus recited in claim 10.

12. A display control program causing a computer to function as each of the first dimming process section and the second dimming process section of the display control apparatus recited in claim 10.

13. A computer-readable recording medium in which the display control program recited in claim 12 is stored.
